(19) United States
(12) Patent Application Publication
(10) Pub. No.: US 2019/0262703 A1
(43) Pub. Date: Aug. 29, 2019

(54) COMPUTER GAME CONTROLLER STAND

(71) Applicant: Arozzi Europe AB, Mjölby (SE)

(72) Inventors: Magnus Johansson, Skänninge (SE); Thomas Andersson, Mjölby (SE)

(21) Appl. No.: 16/334,955

(22) PCT Filed: Sep. 20, 2017
(86) PCT No.: PCT/EP2017/073694

§ 371 Date: Mar. 20, 2019

(30) Foreign Application Priority Data
Sep. 20, 2016 (SE) 1651243-6

(51) Int. Cl. A63F 13/245

(52) U.S. Cl. CPC A63F 13/245; A63F 13/803

(57) ABSTRACT

The present disclosure provides a computer game controller stand, comprising: a frame (10), a controller support (15, 20), connected to the frame, said controller support being configured to support at least one computer game controller, such as a steering wheel module, a joystick module or a pedal module, and a chair connector (122, 132), configured for preventing horizontal relative movement between the frame and a chair (4). The chair connector is adapted to allow the frame and the chair to pivot relative each other about a vertical axis. The disclosure also provides a computer gaming unit and a method of making such a computer gaming unit.

### TECHNICAL FIELD

The present disclosure relates to equipment for enhancing the experience of computer or video gaming, and in particular to a computer game controller stand, to a computer gaming unit and to a method of making a computer gaming unit.

### BACKGROUND

It is known to provide so-called “gaming chairs” or “play seats” in order to enhance gaming experience, especially when playing car racing or flight simulator type computer or video games.

Such gaming chairs or play seats generally comprise a frame, a seat and one or more supports for mounting controller modules.

Gaming chairs or play seats are particularly desirable when using multiple controller modules, such as a hand actuated controller, e.g. a steering wheel module, together with a foot actuated controller, such as a pedal module.

However, gaming chairs are costly and generally bulky and thus take up a lot of space when not in use.

Consequently, relatively few users are prepared to pay for and/or are have the space for, such gaming chairs.

One solution is provided by U.S. Pat. No. 7,8573,11B2, through which a controller stand is connected to the legs of a normal chair.

However, today, many computer gamers like to have an office type chair, or a “swivel chair” with caster wheels. Preferably, such chairs should have at least some of the appearance and properties of an automobile racing seat, e.g. in terms of side support and backrest adjustability.

Hence, the known solution is not applicable to the type of chairs that are preferred by many gamers.

A controller stand according to the pre-characterising portion of claim 1 is also disclosed in US2010/0194155A1.

Hence, there is a need for an improved gaming chair, and in particular for a gaming chair which may enable more users to enjoy an enhanced gaming experience.

### SUMMARY

An object of the present disclosure is to provide a controller stand, which alleviates at least some of the problems mentioned by way of introduction.

The invention is defined by the appended independent claims. Embodiments are set forth in the appended dependent claims, in the following description and in the drawings.

According to a first aspect, there is provided a computer game controller stand, comprising a frame, a controller support, connected to the frame, said controller support being configured to support at least one computer game controller, such as a steering wheel module, a joystick module or a pedal module, and a chair connector, configured for preventing horizontal relative movement between the frame and a chair base.

The chair connector is adapted to allow the frame and the chair to pivot relative each other about a vertical axis.

The chair may be a swivel type chair having a chair base with a number of pivot casters, a seat that is rotatable and optionally height adjustable, relative to the base, and a backrest, which may be fixed or adjustable relative to the seat. Such a chair may, but need not, comprise armrests and/or headrest.

A “pivot caster” means a wheel having an axis of rotation that is pivotable about a vertical axis. Hence, a caster may be an undriven wheel that is mounted to the bottom of a chair, and which, in normal operation, is freely rotatable relative to a base of the chair.

Casters may be mounted in various ways, and many casters are mounted using a vertical pin, which is received in a vertical cylindrical recess, such that the pin is rotatable relative to the recess. The pin and/or the recess may be provided with a locking device for preventing relative axial movement between the pin and the recess.

The connection should preferably prevent relative horizontal movement between the chair and the stand in all horizontal directions. Alternatively, vertical relative movement may also be prevented, or at least reduced.

By connecting the stand to the chair, the seat and the seat supporting portion of the frame can be dispensed with. Hence, a less bulky stand can be provided. That is, the stand takes up less space when not in use.

Moreover, dispensing with the seat, a less costly game seat can be provided. The chair, which the user presumably uses for other purposes as well, can thus provide double functions.

Hence, it is possible to combine a chair having casters, or a chair having one or more of its casters removed, with a game controller stand. Consequently, it is possible to achieve a gaming unit having properties comparable to an integrated gaming chair or play seat, while reducing the cost, as the user can use his/her existing office chair. Moreover, the game controller stand will take up less space when not in use, as it does not comprise any chair.

Moreover, any ergonomic features, such as the adjustability, of the chair can be taken advantages of, also when it is used as a gaming chair.

By allowing rotation between the frame and the chair, or the chair base, easy adjustability can be achieved, thereby allowing use of a variety of chairs.

The chair connector is connectable to a caster or to a chair base pivot caster mount.

The computer game controller stand may comprise a vertically upwardly extending pin, sized and adapted for being received in a caster mounting receptacle of a caster chair base.

Alternatively, the chair connector may be connectable to a caster.

The chair connector may comprise a caster cradle, adapted for receiving a caster of a caster chair, in particular a pivot caster chair.

The caster cradle may comprise an upwardly open receptacle, defining a cradle space.

The cradle space may comprise a proximal edge adapted to prevent the caster from moving in a direction towards the game controller stand.

The proximal edge may be provided by an edge of an opening of the receptacle.

The proximal edge may be provided, at least partially, by a wall of the receptacle.

The cradle space may comprise at least one side edge, adapted to prevent the caster from moving in a lateral direction relative to the rear support member.

The cradle space may comprise a distal edge, adapted to prevent the caster from moving in a direction away from the game controller stand.

The distal edge may present a lower vertical height than the proximal edge.

For example, the distal edge may be on the order of 1-50% of a vertical height of the proximal edge, preferably 5-15% of said vertical height. Thus, a caster may be allowed to roll over the distal edge for introduction to, and/or extraction from, the receptacle. In practical applications, the distal edge may be on the order of 2-20 mm, preferably 2-15 mm or 2-10 mm.

The receptacle may present a bottom surface, on which the caster may rest when received in the receptacle.

The receptacle may be downwardly open, such that the caster received in the receptacle may rest directly on a floor surface.

The computer game controller stand may further comprise a locking device, for preventing the caster from leaving the cradle when received therein.

The locking device may comprise a clamping device, adapted to provide a horizontal clamping force on the caster when received in the cradle.

The locking device may comprise a locking member, which is displaceable relative to the receptacle between a first position wherein the caster can be introduced in, or removed from, the receptacle, and a second position, wherein the caster is prevented from being removed from the receptacle by positive interlocking.

The cradle presents an opening having a first portion, sized and adapted for allowing the caster to pass vertically through it, and a second portion, sized and adapted for allowing a pivot caster mount, but not the entire pivot caster, to extend through it, the second portion being arranged horizontally juxtaposed relative to the first portion.

The chair connector may comprise a downwardly open receptacle, adapted for receiving a pin.

The computer game controller stand may comprise at least two chair connectors and wherein the chair connectors are moveable relative each other in a horizontal direction, such that a distance between the chair connectors is adjustable.

The frame may present a forward direction, parallel with a horizontal direction which a user would face when using the game controller. The forward direction may be a longitudinal direction of the stand.

The frame may comprise a cross member and a pair of longitudinal members extending generally rearwardly from the cross member.

The chair connectors may be provided at a distal end of the respective longitudinal members.

The longitudinal members may be pivotable in a horizontal plane relative to the cross member.

By allowing the rear support members to pivot relative to the cross member, the transversal distance between them may easily be adjusted to accommodate for different chair bases.

The frame of the computer game controller stand may comprise a central member, extending along the forward direction, and wherein the controller support extends upwardly from said central member.

The central member may be movable relative to the cross member, for example by being slidable.

The controller support may be adjustable relative to the frame at least vertically.

The controller support may be adjustable relative to the frame at least horizontally.

The controller stand may comprise a first controller support adapted for receiving a hand-actuated controller and a second controller support adapted for receiving a foot-actuated controller.

The first controller support may be provided rearwardly of the second controller support, as seen in the forward direction.

According to a second aspect, there is provided a computer gaming unit, comprising a computer game controller stand as described above, and a chair configured to be supported on at least three casters. The chair connector is connected to one of the casters or to a pivot caster mount.

The chair connector may be connected to a receptacle for receiving a caster mounting pin.

The chair may be a swivel type chair supported on a plurality of pivot casters.

According to a third aspect, there is provided a method of making a computer gaming unit, comprising providing a computer game controller stand as described above, providing a chair that is configured to be supported on at least three casters, and connecting at least one of the casters or a pivot caster mount to a chair connector of the computer game controller stand.

### BRIEF DESCRIPTION OF THE DRAWINGS

FIGS. 1a-1b schematically illustrate a controller stand.

FIG. 2 schematically illustrate a controller stand fitted with controller modules.

FIGS. 3a-3c schematically illustrate a gaming unit, comprising a controller stand fitted with controller modules and a gaming chair.

FIG. 4 schematically illustrates a chair connector.

FIGS. 5a-5c schematically illustrate a caster cradle 16.

FIGS. 6a-6c schematically illustrate a caster cradle 17.

FIGS. 7a-7c schematically illustrate a caster cradle 18.

FIGS. 8a-8c schematically illustrate a caster cradle 19.

FIGS. 9a-9b schematically illustrate another design of a controller stand.

### DETAILED DESCRIPTION

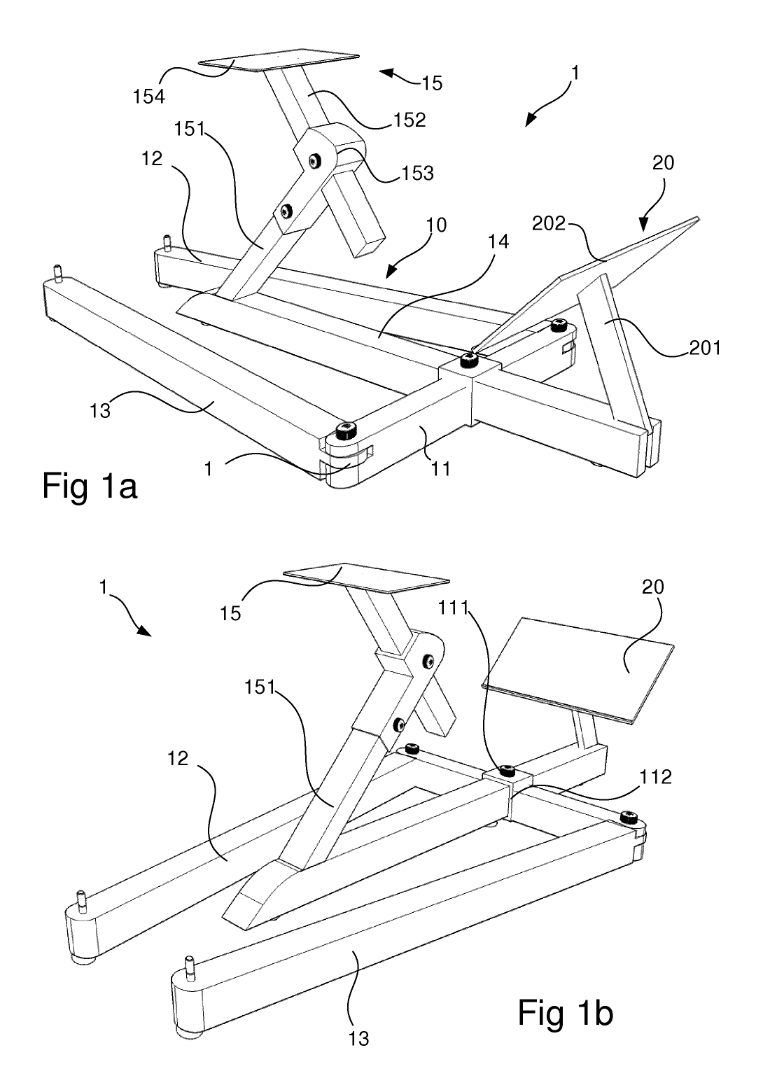

FIGS. 1a-1c schematically illustrate an example of a video game controller stand 1 according to the present disclosure.

The stand 1 comprises a frame 10, which is formed of a cross member 11, a pair of elongate rear support members 12 13, a central longitudinal support member 14 and a pair of controller supports 15, 20. A first one of the controller supports 15 is adapted for receiving a hand controller 2 and the second one 15 is adapted for receiving a foot controller 3.

The controller supports 15, 20 may be connected to the central support member 14. For example, the hand controller support 15 may be arranged rearwardly of the cross member 11 and the foot controller support may be arranged forward of the cross member 11.

The central support member 14 may be movable relative to the cross member 11, such that the position of the controller supports 15, 20 may be adjustable. For example, the central support member 14 may be slidable relative to a central portion 111 of the cross member 11.

Such slidable arrangement may be provided by providing a through recess 112 in the cross member. Such through recess 112 may have a cross section which corresponds to a cross section of the central support member. In such recess one or more guides or bearings may be provided. For example a polymer material lining may be provided.

The slidable arrangement may be provided with a locking device for locking the central support member relative to the cross member.

The locking device may be a friction locking device which may operate towards a surface of the central support member.

For example, the locking device may comprise a wedge member, which when brought into engagement with the central support member provided frictional locking.

Alternatively, the locking device may operate towards a plurality of predetermined and optionally fixed engagement points in the central support member.

For example, the locking device may comprise a pin, which may be biased towards a locked position, and a corresponding hole or recess in the longitudinal support member.

The rear support members 12, 13 may extend rearwardly from lateral distal portions 113, 114 of the cross member 11.

The rear support members 12, 13 may be fixedly connected to the cross member 11.

Alternatively, the respective the rear support members 12, 13 may be pivotably connected to the cross member, such that the rear support members may pivot about a respective vertical axis relative to the cross member.

Referring to FIG. 1 a, upwardly extending members 151, 201 may be provided for the controller supports 15, 20. These members may be fixedly connected to the central member 14, at respective ends thereof.

A hand controller upwardly extending member 151 may extend upwardly at an angle of 30°-150° relative to the central member 14. In the illustrated example, the angle may be about 40°-70°.

A second upwardly extending member 152 may be provided. This second member may be adjustable relative to the first member 151. For example, the second upwardly extending member may extend at an angle of about 70°-110°, preferably about 90°, relative to the first member 151.

The second member 152 may be adjustable by a sliding mechanism, similar to that provided for the central member 14 relative to the cross member 11. This mechanism may be provided in a connector 153, which may be formed as a separate part, to which the first and second members 151, 152 are connectable. This separate part may be formed of a metallic or plastic material.

A hand controller support surface 154 may be provided in the form of a planar member of metallic or plastic material.

The foot controller support may comprise a vertical member 201 and a support surface 202, which may be formed of a planar member of a metallic or plastic material.

The vertical member may be fixedly attached or attachable to the central member. Alternatively, an angle between the vertical member 201 and the central member 14 may be adjustable.

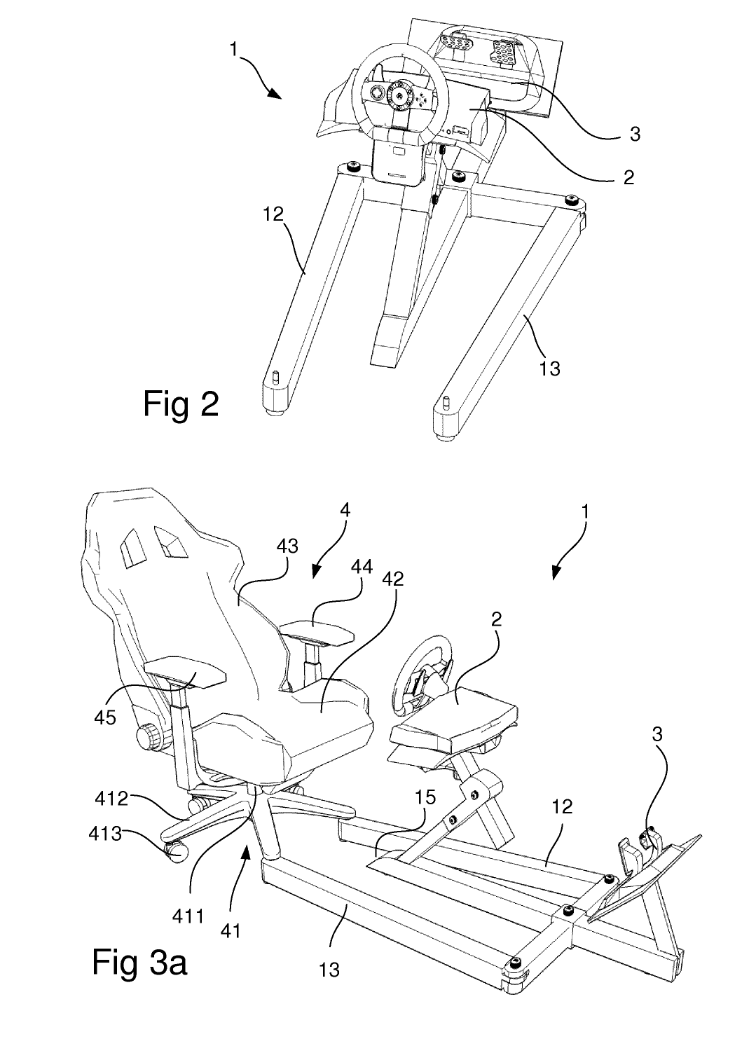

FIG. 2 illustrates the stand with controllers 2, 3 mounted thereon.

A hand controller 2 has been mounted on the hand controller support 15. This hand controller 2 has the form of a steering wheel module. Such steering wheel modules are known as such and may comprise a steering wheel, a number of buttons and/or gear shifter, e.g. in the form of paddles or in the form of a gear stick.

Alternatively, the hand module may comprise a joystick, which may be supplemented by a throttle regulator, e.g. in the form of a slidable controller.

A foot controller 3 has been mounted on the foot controller support 20. This foot controller comprises a plurality of pedals, three in the illustrated example, but may comprise any number of pedals, typically one, two or three.

Controllers 2, 3 may be mounted to the controller supports 15, 20 by any type of mounting device. Examples of such mounting devices include straps, hook-and-loop type fasteners, clamping devices or even threaded connectors, such as nut-and-bolt connectors.

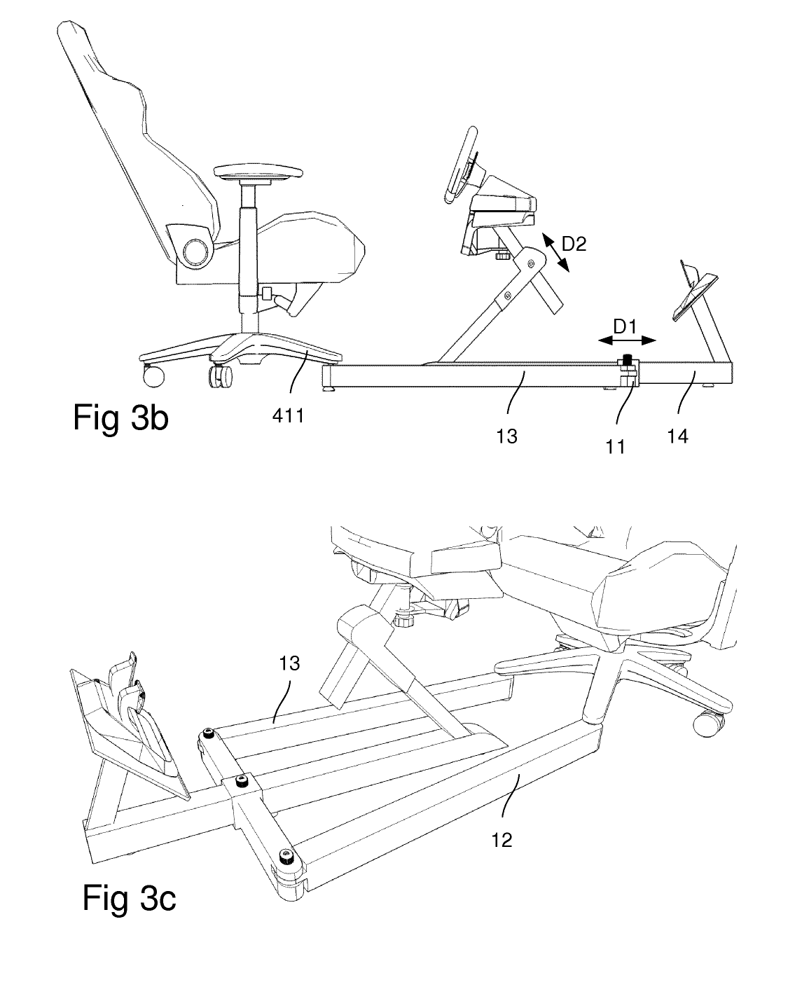

FIGS. 3a-3b schematically illustrate the stand 1 with controllers 2, 3 when connected to a chair 4, here in the form of a swivel type gaming chair.

In the illustrated example, the chair connectors comprises a respective upwardly extending pin 123, 133, which is adapted to be introduced into corresponding downwardly open caster mounting pin recesses of the chair base 41. Hence, in order to connect the chair connectors to the chair, one or more casters need to be removed from the chair base 41, after which the pins 123, 133 are introduced into the respective caster mounting pin recess.

Hence, the stand 1 illustrated in FIGS. 1a-1c is adapted for connection to a swivel type chair 4, comprising a chair base 41 having a centrally located vertical member 411 and a plurality of arms 412, which connect at their respective proximal ends and which, at their respective distal ends are provided with a caster.

Typically, such chairs may comprise three or more pivot casters 413, typically four or five. The chair 4 may further comprise a seat 42, a backrest 43 and a pair of armrests 44, 45.

The controller supports 15, 20 may be adjustable relative to the remainder of the frame.

Preferably, each controller support 15, 20 may be adjustable, such that the stand 1 can be adapted for users of different sizes.

For example, referring to FIG. 3b, the central support member 14 may be adjustable relative to the cross member 11, as described earlier, along a first longitudinal direction D1. Through this adjustment, the distance between the chair and both controllers may be adjusted simultaneously.

Moreover, the vertical position of the hand controller 2 may be adjusted along a second direction D2, which may present an angle of 0-90 degrees relative to the first direction. In the illustrated example, the second direction D2 presents an angle of about 30-60 degrees relative to the first direction D1.

The adjustment mechanism of this hand controller support 15 may be the same as that of the central support member 14 relative to the cross member 11.

As an alternative, the first controller support 15 may have one adjustment for height (substantially perpendicular, such as about 80°-100° relative to the first direction D1), and one adjustment for length (substantially parallel, such as about −10°-10° relative to the first direction D1).

Moreover, an angle of the first controller support surface may be adjustable.

The second controller support 20 may, as illustrated, be fixed.

As an alternative, the second controller support 20 may have one adjustment for height (substantially perpendicular, such as about 80°-100° relative to the first direction D1), and one adjustment for length (substantially parallel, such as about −10°-10° relative to the first direction D1).

Moreover, an angle of the second controller support surface may be adjustable.

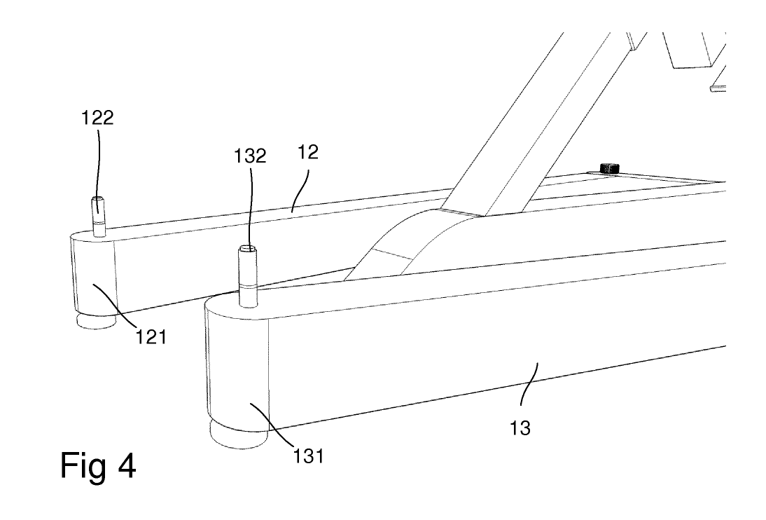

FIG. 4 illustrates in detail the rearwardly distal portions of the rear support members 12, 13.

At the rearwardly distal portion 121, 131 of the rear support members 12, 13, a respective chair connector 122, 132 is provided, for connection to the base 41 of a chair 4.

The parts forming the frame, including the members 11, 12, 13, 14 may be formed of a metallic material, such as steel or aluminum, with any cross section deemed suitable, such as rectangular, square or circular.

As an alternative to removing one or more pivot casters from the chair base 41 to allow for connection to the stand 1, it is possible to provide a caster cradle. Such a caster cradle may comprise a frame or other type of base, into which the caster, while mounted on the chair, can be placed, whereby horizontal relative movement between the chair 4 and the stand 1 is prevented. Optionally, a locking device may be provided for preventing also vertical relative movement.

The description will now focus on embodiments comprising a caster cradle.

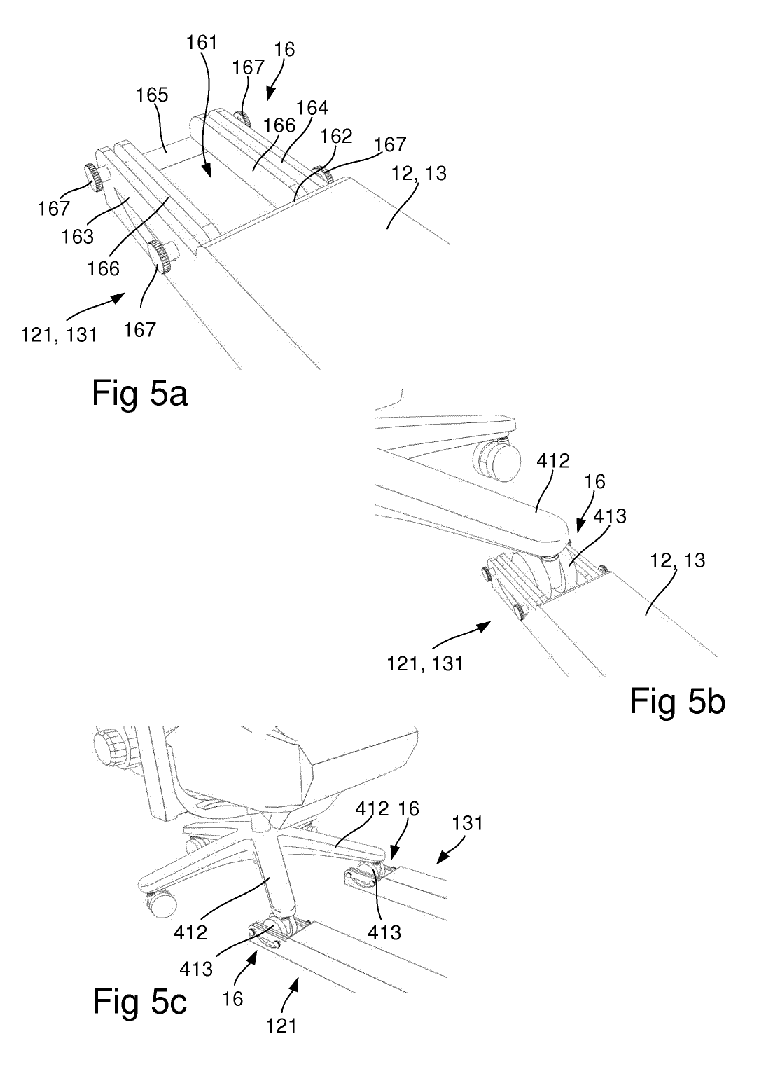

FIGS. 5a-5c schematically illustrate a first embodiment of a computer game controller stand comprising a caster cradle 16.

FIG. 5a schematically illustrates a distal portion of a pair of rear support members 12, 13 of a controller stand.

FIG. 5b schematically illustrates the distal portion 121, 131 with a pivot caster 413 received therein.

FIG. 5c schematically illustrates a pair of such distal portions 121, 131 with respective pivot casters 413 received therein.

The distal portion 121, 131 of the rear support member 12, 13 forms a caster cradle 16, which is defined by a proximal edge 162, a pair of side edges 163, 164 and a distal edge 165.

The proximal edge 162 may be flush with an upper surface of the rear support member 12, 13.

The side edges 163, 164 may extend from laterally spaced portions of the proximal edge 162 towards the distal edge 165.

The distal edge 165 may extend between distal portions of the side edges 163, 164.

The distal edge 165 may be lower than the proximal edge 162. For example, a vertical height of the distal edge 165 may be less than 50% of a height of the proximal edge 162, preferably less than 30% or less than 10%. Hence, a caster 413 may easily be introduced into the cradle 16 by merely passing over the distal edge 165.

One or both of the side walls 163, 164 may be provided with clamps 166, 167, which are adapted to clamp the caster 413 to prevent it from moving once it has been received in the caster cradle 16.

Such clamps 166, 167 may be formed by a clamping member 166, which is movable relative to the cradle edge 163, 164 and at least one actuator member 167, which here is illustrated by a threaded members, which, when rotated causes the clamping member 166 to move relative to the cradle edge 163, 164.

In the illustrated embodiment, each clamping member 166 may be provided with a pair of such threaded members 167. Each cradle 16 may be provided with one or two such clamping members 166.

As illustrated, the cradle 16 may form an upwardly and downwardly open receptacle 161. Thus, the caster 413 may be introduced through a substantially vertical relative movement between the caster 413 and the rear support member 12, 13, whereby the caster 413 will come to rest directly on the floor surface, on which the chair and the computer game controller stand are positioned.

In order to connect the chair 4 to the cradle 16, the locking members 166 are brought to a position which allows the caster 413 to be introduced into the cradle 16. The caster 413 is then introduced into the cradle 16, either through a vertical motion, or through rolling over the distal edge 165. Once the caster 413 is properly received in the cradle 16, the locking members 166 are activated, e.g. tightened, such that the caster 413 is locked into position.

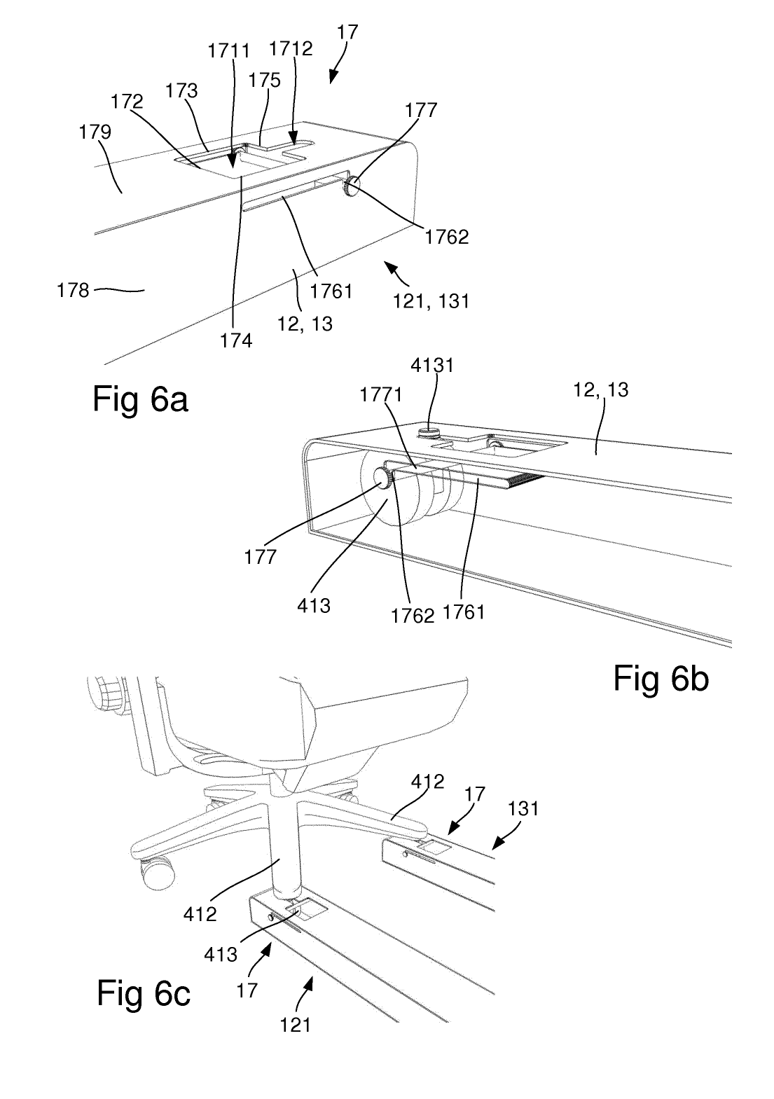

FIGS. 6a-6c schematically illustrate a second embodiment of a computer game controller stand comprising a caster cradle 17.

FIG. 6a schematically illustrates a distal portion of a pair of rear support members 12, 13 of a controller stand.

FIG. 6b schematically illustrates the distal portion 121, 131 with a pivot caster 413 received therein, and the chair base left out, for clarity.

FIG. 6c schematically illustrates a pair of such distal portions 121, 131 with respective pivot casters 413 received therein, and with the chair base 412 visible.

The distal portion 121, 131 of the rear support member forms a caster cradle 17, which is defined by a proximal edge 172, a pair of side edges 173, 174 and a distal edge 175. Sides of the support members 12, 13 may be open or closed.

In this embodiment, the caster cradle 17 presents an opening 1711, 1712 of a “keyhole” type, with a first portion 1711 through which the caster 413 can be introduced by a relative vertical motion, and a second portion 1712, which is large enough for the caster pivot mount 4131 to extend through, but small enough to prevent the caster 413 from passing there through.

In the illustrated embodiment, the second portion 1412 is formed as a slit extending perpendicular from one of the edges 175 of the first portion 1711.

Depending on the height of the rear support member 12, 13, the chair base 412 may be caused to rest on the upper surface 179 of the rear support member 12, 13. Thus, the caster 413 may not take any vertical load from the chair 4 when received in the cradle 17.

Alternatively, the rear support member 12, 13 may be low enough for the caster member 413 to reach a bottom surface of the cradle 17, to thus take some, or all, of the vertical load from the chair 4.

The cradle 17 illustrated in FIGS. 6a-6c may (but need not) be provided with a locking device 1761, 1762, 177. In the illustrated embodiment, the locking device may comprise one or two slots 1761, 1762 extending in the length direction of the rear support member 12, 13.

The slot 1761, 1762 may comprise a longitudinal portion 1761 and one or more locking portions 1762, each of which may extend downwardly from the longitudinal portion 1761.

The locking device 1761, 1762, 177 may further comprise a locking member 177, which is displaceable in the slot 1761, 1762 between a first position (here at a proximal part of the cradle 17), in which the caster 413 is allowed to leave or enter the first portion 1711 of the opening; and a second position (here at a distal portion of the cradle 17), in which the caster 413 is locked into position and thus prevented from leaving the cradle 17.

The locking member 177 may comprise a pin 1771. Such pin may be axially biased so as to prevent it from moving, or at least to prevent it from rattling.

Alternatively, the pin 1771 may be provided with a thread, such that it can be tightened when positioned e.g. at a desired locking position.

In order connect the chair 4 to the cradle 17 of FIGS. 6a-6c, the locking member 177 is positioned at the proximal portion of the longitudinal slots 1761, after which the caster 413 is introduced into the first portion 1711 of the opening. The caster 413 is then moved horizontally towards the distal portion of the opening and into the second portion 1712 of the opening. When the caster 413 has been positioned at the desired position, the locking member 177 may be slid towards the distal portion of the slot 1761 and vertically into the locking portion 1762 of the slit. At this point, the locking member 177 may simply be allowed to remain in position by gravity, or it may be biased or tightened so as to prevent it from leaving its position.

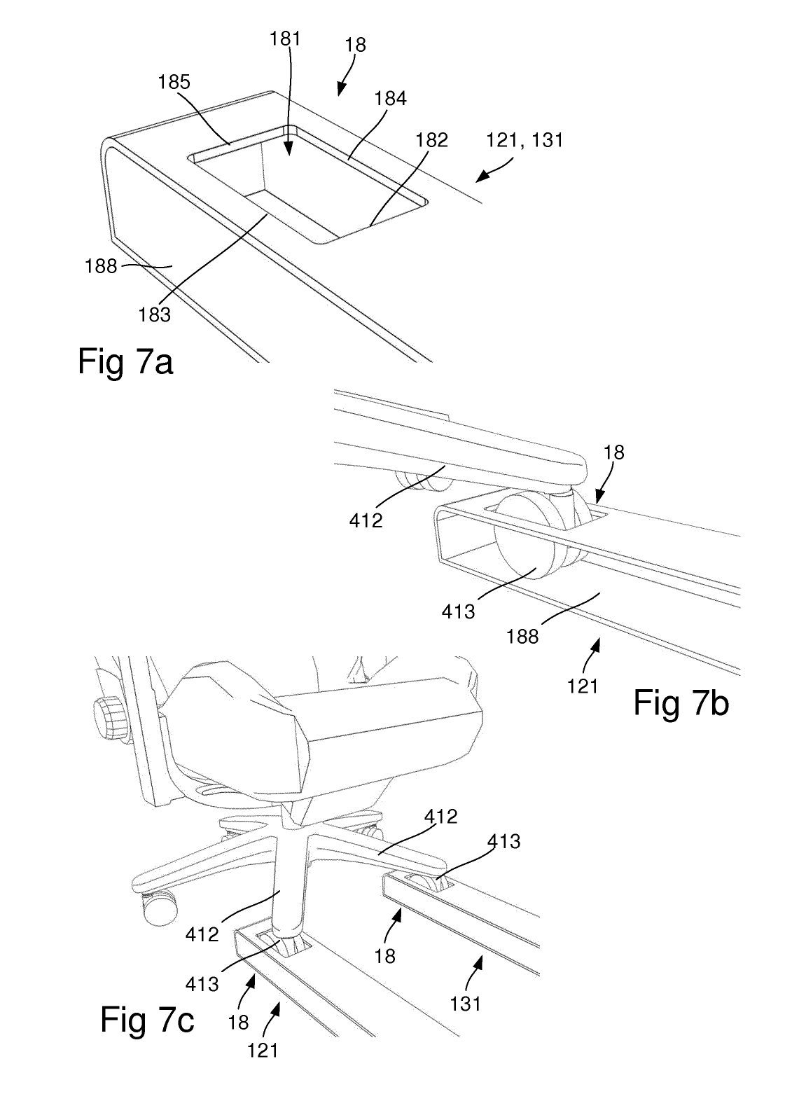

FIGS. 7a-7c schematically illustrate a third embodiment of a computer game controller stand comprising a caster cradle 18.

FIG. 7a schematically illustrates a distal portion of a pair of rear support members 12, 13 of a controller stand.

FIG. 7b schematically illustrates the distal portion 121, 131 with a pivot caster 413 received therein.

FIG. 7c schematically illustrates a pair of such distal portions 121, 131 with respective pivot casters 413 received therein.

In the embodiment of FIGS. 7a-7c, the caster cradle 18 is simply formed by a rear support member 12, 13 having a substantially rectangular cross section and being provided with an upwardly open opening 181, which is sized to receive a pivot caster 413 of a chair 4. The opening may be defined by a proximal edge 182, a pair of side edges 183, 184 and a distal edge 185. The opening 181 may present a length and width which are about 101-120% of the corresponding dimension of the pivot caster 413.

Sides of the support members 12, 13 may be open or closed.

Moreover, in this embodiment, the cradle 18 presents a bottom surface 188, on which the caster 413 may rest when received in the cradle 18.

In this embodiment, it is preferred if the support members 12, 13 present a vertical height of about 30-75% of a caster wheel diameter.

To connect the chair to the cradle, the chair is simply lifted and the casters 413 are allowed to be received in the cradles 18 through the openings 181. In practical applications, this may imply a height of about 10-40 cm, preferably 20-30 mm.

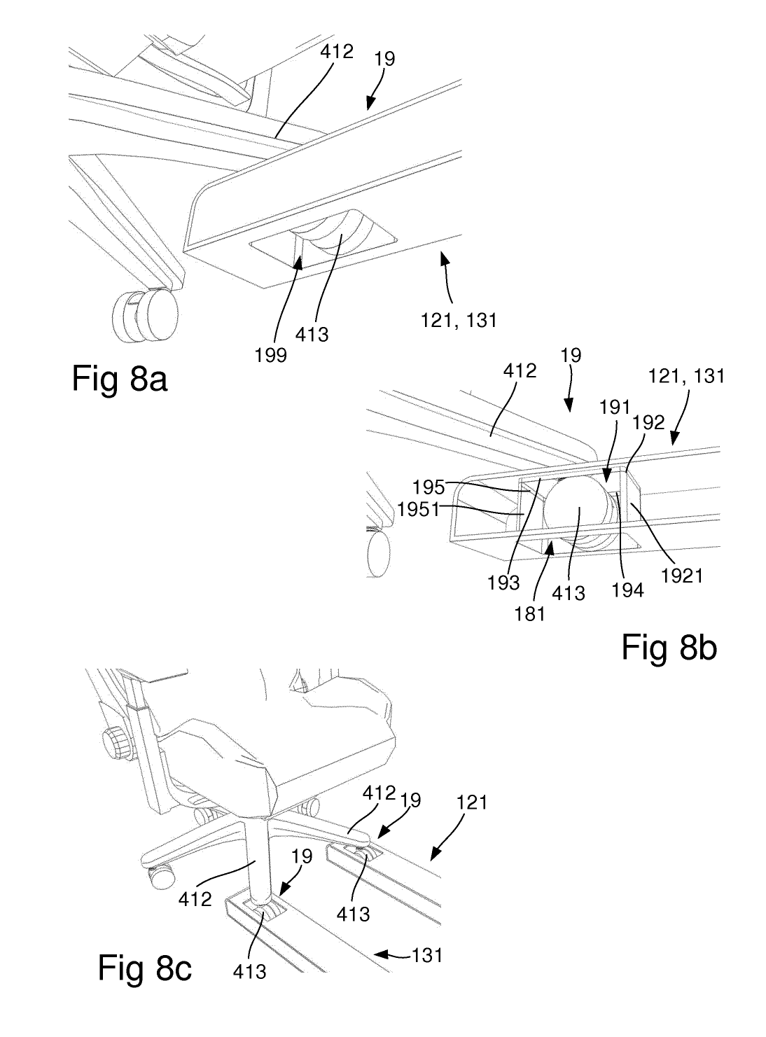

FIGS. 8a-8c schematically illustrate a fourth embodiment of a computer game controller stand comprising a caster cradle 19.

FIG. 8a schematically illustrates a distal portion 121, 131 of a pair of rear support members 12, 13 of a controller stand.

FIG. 8b schematically illustrates the distal portion 121, 131 with a pivot caster 413 received therein.

FIG. 8c schematically illustrates a pair of such distal portions 121, 131 with respective pivot casters 413 received therein.

The embodiment of FIGS. 8a-8c is similar to that of FIGS. 7a-7c, but with the difference that the cradle 19 does not present any bottom surface. Thus the caster 413, when received in the cradle 19, will rest directly on the floor surface.

Hence, the cradle 19 is defined by an upper opening 191 having a proximal edge 192, a pair of side edges 193, 194 and a distal edge 195. The cradle may, but need not, comprise a lower opening 199 through which the caster 413 may contact the floor surface.

Moreover, the cradle has been provided with at least one vertical wall 1921, 1951, here actually two such walls; a proximal vertical wall 1921 and a distal vertical wall 1951; which reduce the amount of horizontal relative movement between the caster 413 and the support member 12, 13.

In this embodiment, the support members 12, 13 may present a greater vertical height than in FIGS. 7a-7c, and may be on the order of 75-110% of a caster diameter.

It is understood that, while the frame may preferably be formed of metal, such as steel or aluminum (or alloy), the cradles 16, 17, 18, 19 may be wholly or partially provided with lining material that may help prevent wear on the casters 413 and/or which may prevent noise from being generated by the interaction between the caster 413 and the cradle 16, 17, 18, 19. Such liners may be formed of a polymer material, such as plastic, rubber, etc., or from a woven material or a non-woven material, such as fabric or felt.

The liner may be provided on one or more of the edges, on one or more of the walls or on any vertically supporting surface.

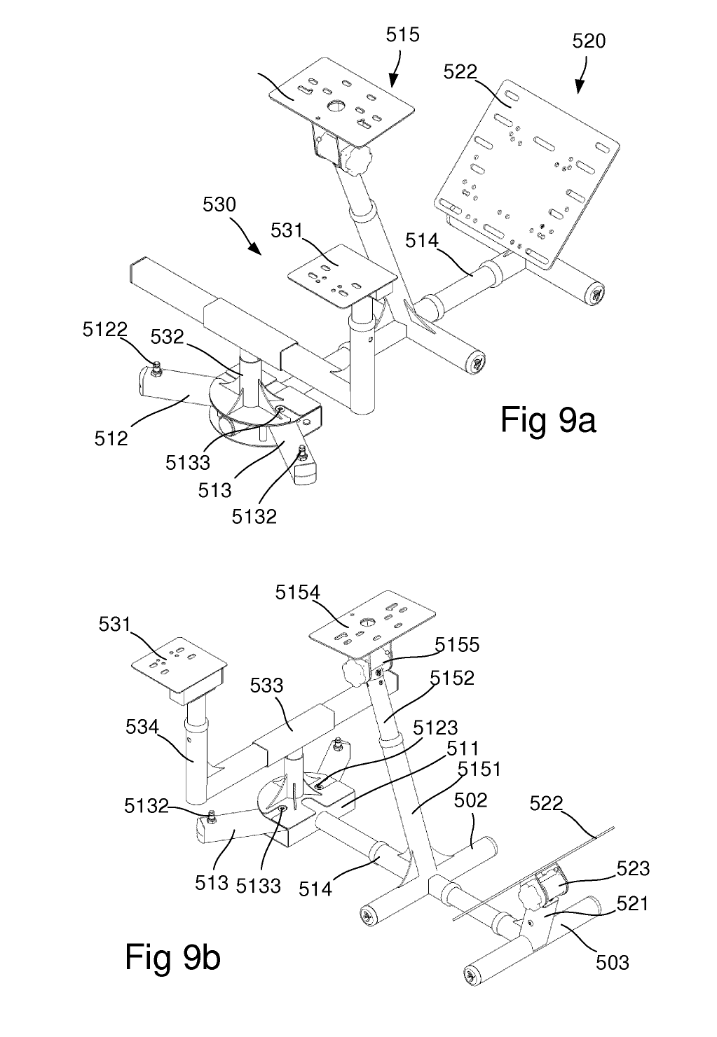

Referring to FIGS. 9a-9b, there is illustrated another embodiment of a computer game controller stand.

This computer game controller stand comprises a central member 514, which may be formed by a tubular member of fixed or variable length. Such variable length may be achieved by telescope action.

At least one cross member 502, 503, 511 may be provided to prevent the stand from tipping over sideways.

At distal portions of one of the cross members 511, the longitudinal members 512, 513 may be arranged. These longitudinal members are pivotable relative to the cross member 511 about a respective vertical axis 5133, 5123.

At distal ends of the longitudinal members 512, 513, a respective chair connector 5122, 5132 is provided. The chair connectors may, as non-limiting examples, be designed according to any of the embodiments disclosed in the preceding figures.

A hand controller support 515 may comprise a hand controller upwardly extending member 5151 extending upwardly at an angle of 30°-150° relative to the central member 514, preferably about 50°-105° or about 65°-85°. In the illustrated example, the angle may be about 60°-70°.

A second upwardly extending member 5152 may be provided. This second member may be adjustable relative to the first member 5151, e.g. by telescopic engagement.

The hand controller support surface 5154 may be adjustable relative to the second member by means of an angle adjustment mechanism 5155, at least with respect to angle about a horizontal axis extending perpendicular to the main member 514.

The hand controller support surface 5154 may be provided in the form of a planar member of metallic or plastic material.

A foot controller 520 support may comprise a vertical member 521 and a support surface 522, which may be formed of a planar member of a metallic or plastic material. An angle adjustment mechanism 523 may be provided to allow the foot controller support to be adjusted at least with respect to angle about a horizontal axis extending perpendicular to the main member 514.

The vertical members 5151, 521 may be fixedly attached or attachable to the central member 514. Alternatively, an angle between the vertical members and the central member 514 may be adjustable.

In addition, the controller stand of FIGS. 9a-9b may comprise an auxiliary hand controller support 530, which may be used e.g. to support a gear shifter, which may be used together with a steering wheel module that is supported by the hand controller support 515. The auxiliary hand controller support 530 may comprise a support member 531, which may provide a generally flat surface and means, such as holes, etc., for attaching the gear shifter to it.

The auxiliary hand controller support 530 may further comprise a first vertical member 532, which may be attached to the frame of the computer game controller stand, e.g. on or near one of the cross members 511, 502, 503. The first vertical member may be rotatable about a vertical axis.

The auxiliary hand controller support 530 may further comprise a horizontal member 533, which may be supported at an upwardly distal portion of the first vertical member 532.

At a distal portion of the horizontal member 533, there may be provided a second vertical member 534, which connects the horizontal member 533 with the support member 531.

The tubular members may have a cross section which may be approximately generally circular, generally square, generally rectangular, etc.

1. A computer game controller stand, comprising:
a frame,
a controller support, connected to the frame, said controller support being configured to support at least one computer game controller, such as a steering wheel module, a joystick module or a pedal module, and
a chair connector, configured for preventing horizontal relative movement between the frame and a chair,
the chair connector is adapted to allow the frame and the chair base (412) to pivot relative each other about a vertical axis,
wherein the chair connector is connectable to a chair base pivot caster mount.

2. The computer game controller stand as claimed in claim 1, wherein the chair connector comprises a vertically upwardly extending pin, sized and adapted for being received in a caster mounting receptacle of a caster chair base.

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. The computer game controller stand as claimed in claim 1, wherein the computer game controller stand comprises at least two chair connectors, and wherein the chair connectors are moveable relative each other in a horizontal direction, such that a distance between the chair connectors is adjustable.

18. The computer game controller stand as claimed in claim 1, wherein the frame presents a forward direction, parallel with a horizontal direction which a user would face when using the game controller.

19. The computer game controller stand as claimed in claim 1, wherein the frame comprises a cross member and a pair of longitudinal members extending generally rearwardly from the cross member.

20. The computer game controller stand as claimed in claim 19, wherein the chair connectors are provided at a distal end of the respective longitudinal members.

21. The computer game controller stand as claimed in claim 19, wherein the longitudinal members are pivotable in a horizontal plane relative to the cross member.

22. The computer game controller stand as claimed in claim 1, wherein the frame comprises a central member, extending along the forward direction, and wherein the controller support extends upwardly from said central member.

23. (canceled)

24. (canceled)

25. (canceled)

26. The computer game controller stand as claimed in claim 1, wherein the controller stand comprises a first controller support adapted for receiving a hand-actuated controller and a second controller support adapted for receiving a foot-actuated controller.

27. (canceled)

28. The computer game controller stand as claimed in claim 1, further comprising an auxiliary game controller support.

29. (canceled)

30. A computer gaming unit, comprising:
a computer game controller stand comprising:
a frame,
a controller support, connected to the frame, said controller support being configured to support at least one computer game controller, such as a steering wheel module, a joystick module or a pedal module, and
a chair connector, configured for preventing horizontal relative movement between the frame and a chair,
the chair connector is adapted to allow the frame and the chair base to pivot relative each other about a vertical axis,
wherein the chair connector is connectable to a chair base pivot caster mount,
a chair configured to be supported on at least three casters,
wherein the chair connector is connected to one of the casters or to a pivot caster mount.

31. (canceled)

32. The computer gaming unit as claimed in claim 30, wherein the chair is a swivel type chair.

33. A method of making a computer gaming unit, comprising:
providing a computer game controller stand comprising:
a frame,
a controller support, connected to the frame, said controller support being configured to support at least one computer game controller, such as a steering wheel module, a joystick module or a pedal module, and
a chair connector, configured for preventing horizontal relative movement between the frame and a chair,
the chair connector is adapted to allow the frame and the chair base to pivot relative each other about a vertical axis,
wherein the chair connector is connectable to a chair base pivot caster mount,
providing a chair that is configured to be supported on at least three casters, and
connecting at least one of the casters or a pivot caster mount to a chair connector of the computer game controller stand.

34. The method as claimed in claim 33, further comprising removing at least one caster from the chair prior to said connecting step.

35. A computer game controller stand, comprising:
a frame, a controller support, connected to the frame, said controller support being configured to support at least one computer game controller, such as a steering wheel module, a joystick module or a pedal module, and
a chair connector, configured for preventing horizontal relative movement between the frame and a chair,
wherein the chair connector is adapted to allow the frame and the chair base to pivot relative each other about a vertical axis,
wherein the frame comprises a cross member and a pair of longitudinal members extending generally rearwardly from the cross member,
wherein the chair connectors are provided at a distal end of the respective longitudinal members, and
wherein the longitudinal members are pivotable in a horizontal plane relative to the cross member.

36. The computer game controller stand as claimed in claim 35, wherein the chair connector comprises a vertically upwardly extending pin, sized and adapted for being received in a caster mounting receptacle of a caster chair base.

37. The computer game controller stand as claimed in claim 35, wherein the caster cradle comprises an upwardly open receptacle, defining a cradle space.

38. The computer game controller stand as claimed in claim 35, wherein the computer game controller stand comprises at least two chair connectors, and wherein the chair connectors are moveable relative each other in a horizontal direction, such that a distance between the chair connectors is adjustable.

39. A computer gaming unit, comprising:
a computer game controller stand as claimed in claim 35, and
a chair configured to be supported on at least three casters,
wherein the chair connector is connected to one of the casters or to a pivot caster mount comprising a receptacle for receiving a caster mounting pin.
